(19) United States
(12) Patent Application Publication
(10) Pub. No.: US 2022/0186087 A1
(43) Pub. Date: Jun. 16, 2022

(54) TRANSPARENT FLAME-RETARDANT COMPOSITIONS AND LABELS INCLUDING SAME

(71) Applicants: Shuhui XIE, Glendale, CA (US); Yu WANG, Glendale, CA (US); Biao SHEN, Glendale, CA (US); Yurun YANG, Glendale, CA (US); Zhongfei LV, Glendale, CA (US); Avery Dennison Corporation, Glendale, CA (US)

(72) Inventors: Shuhui XIE, Kunshan City (CN); Yu WANG, Suzhou Industrial Park (CN); Biao SHEN, Shanghai (CN); Yurun YANG, Shanghai (CN); Zhongfei LV, Kunshan (CN)

(21) Appl. No.: 17/426,992

(22) PCT Filed: Feb. 2, 2019
(86) PCT No.: PCT/CN2019/074623

§ 371 Date: Jul. 29, 2021

(51) Int. Cl. C09J 7/50; C09D 5/18; C09D 7/63; C09D 167/00; C09D 133/04; C09K 21/12; C09J 11/06

(52) U.S. Cl. CPC C09J 7/50; C09D 5/18; C09D 7/63; C08K 5/5313; C09D 133/04; C09K 21/12; C09J 11/06; C09D 167/00

(57) ABSTRACT

The present disclosure relates to transparent flame-retardant coating compositions and labels including layers comprising the same. The coating composition comprises a high-hydroxyl value polymer, a crosslinker, and a flame-retardant additive comprising a phosphinate compound. The coating composition may be coated on a substrate such as a label. The coating composition forms a layer that advantageously has flame-retardant properties and is optically clear.

### FIELD

The present disclosure generally relates to transparent flame-retardant compositions and labels comprising the same. More particularly, the present disclosure relates to compositions that exhibit good flame retardancy without using halogen-based flame retardants, while having excellent optical clarity.

### BACKGROUND

Labels that are flame retardant are desired for many situations, including labeling electrical equipment, e.g., a battery, where there is an increased chance of fire hazard due to extended period of operation of the electrical equipment. For example, flame retardant labels are used in applications such as cables, printed circuit boards (PCB), printed wiring boards (PWB) and batteries. To be fully utilized with electrical equipment, labels also require good printability and good adhesion performance. Further, the amounts of components present in the various layers of the labels must be controlled such that production of the labels is cost effective.

Conventionally, labels having flame retardant properties are produced by stacking multiple layers of flame-retardant topcoat, film, and adhesives. The topcoat layer of some conventional labels often comprise polymeric resins that lack sufficient thermal decomposition resistance e.g., having a low char yield. Char yield for polymers is defined as the amount of solid residue at 930° C. in a nitrogen atmosphere and in general, a higher char yield is associated with a higher thermal decomposition resistance and a higher flame retardance. Various formulations of coating compositions, e.g., topcoat compositions or primer compositions, are generally known in the art. Additionally, many existing topcoats demand modification to achieve desired performance of processing requirements. These modifications may include external additives, crosslinkers, or other modifiers.

However, flame retardants added to a coating composition, e.g., the topcoat or the primer layer, often compromise the label's optical characteristics and adhesion performance. Thus, in order to compensate for the problems caused by flame retardants, manufacturers often increase the amount of other constituents of a different layer that contributes to the adhesion performance or optical performance of the label. Unfortunately, these adjustments typically cause increases in production costs and inconveniences in label application. It is also challenging to incorporate flame retardant materials into polymeric films without compromising their optical clarity. In fact, most flame retardant compositions generally form opaque layers.

U.S. Pat. No. 4,207,374 discloses a flame-retardant film containing a flame-retardant topcoat layer comprising polyester/epoxy resin. The reference also discloses a label comprising an adhesive layer comprising acrylics and rubber/resin.

US Publication No. 2018/0072922A1 discloses pressure-sensitive adhesive formulations based on acrylic or rubber adhesives that are provided in combination with an aluminum phosphorous salt intumescent flame retardant and a nitrogen containing flame retardant which can act as a blowing agent through thermal decomposition. These flame retardant additives are incorporated into the adhesive in levels of 10 to 30 percent by weight. These formulations are placed on a polymeric flame retardant substrate in either a single-sided or double-sided form.

US Publication No. 2014/0162058A1 discloses a flame retardant adhesive layer coated on at least a portion of a PET film backing. The adhesive layer comprises a methacrylate-based block copolymer and at least 10% halogen-free flame retarding agent. The adhesive layer may optionally contain tackifying resins. US20140162058A1 does not disclose whether the label meets the flame-retardancy requirements under any of the UL 94 VTM standards.

WO 2011029225A1 discloses a multi-layer label comprising a flame-retardant topcoat layer, a film layer and a flame-retardant adhesive layer. The label demonstrates a flame-retardant performance that meets the UL 94 VTM-0 standard. The topcoat layer comprises a mixture of polyurethane resin and phenoxy resin. The top surface of the topcoat layer is a printable surface. The adhesive layer comprises pressure sensitive adhesives such as an acrylic. The backing film has a thickness of 25 microns and the topcoat layer has a thickness of 18 microns. The application discloses that the adhesive layer, if not flame retardant, is optimally 20 microns; but if the adhesive layer contains a flame retardant, it is desirable to extend the adhesive layer to a greater thickness, to as much as 100 microns to provide more flexibility.

None of the above-disclosed references, however, provide for compositions that meet the flame-retardant requirements under any of the UL 94 VTM standards, while remaining optically clear. In view of the foregoing drawbacks, the need exists for a coating composition having effective and stable flame-retardant properties and at the same time having appropriate transparency.

### SUMMARY

In some embodiments, the present disclosure relates to a coating composition comprising: a base polymer having a hydroxyl value greater than 100 mgKOH/g; a crosslinker comprising an isocyanate compound; and a flame retardant additive comprising a phosphinate compound. In some cases, the base polymer has a hydroxyl value ranging from 100 mgKOH/g to 350 mgKOH/g. In some cases, some of the hydroxy groups of the base polymer complex with some of the phosphinate compound to form a hydroxy-phosphinate complex. In some cases, the coating composition further comprises at least 20 wt. % hydroxy-phosphinate complex. In some cases, the coating composition has a haze value of less than 20%. In some cases, the weight ratio of polymer to flame retardant additive ranges from 0.2:1 to 10:1. In some cases, the polymer comprises a polyester, or a polyacrylate, or combinations thereof. In some cases, the base polymer is present in an amount ranging from 20 wt. % to 60 wt. %, based on the total weight of the composition. In some cases, the crosslinker is present in an amount ranging from 10 wt. % to 40 wt. %, based on the total weight of the composition. In some cases, the flame retardant additive is present in an amount ranging from 20 wt. % to 60 wt. %, based on the total weight of the composition. In some cases, the crosslinker consists of the isocyanate compound. In some cases, the phosphinate compound comprises methylethyl phosphinates, diethyl phosphinates, aluminum methylethyl phosphinate, aluminum diethyl phosphinate, zinc methylethyl phosphinate, zinc diethyl phosphinate, aluminum phosphinate, magnesium phosphinate, calcium phosphinate, zinc phosphinate, or combinations thereof. In some cases, the phosphinate compound comprises aluminum diethyl phosphinate. In some cases, the flame retardant additive has an average particle size distribution less than 2 micron. In some cases, the coating composition has a UL rating of VTM-0. In some cases, the polymer comprises a hydroxyl value greater than 100 mgKOH/g, the flame retardant additive comprises aluminum diethyl phosphinate ranging from 20 wt. % to 60 wt. %, based on the total weight of the composition, and the coating composition has a UL rating of VTM-0. In some cases, the polymer comprises a hydroxyl value greater than 100 mgKOH/g, the phosphinate compound comprises aluminum diethyl phosphinate having an average particle size distribution less than 2 micron, and the coating composition has a haze value less than 20%. In some cases, the polymer comprises a polyester or a polyacrylate having a hydroxyl value greater than 100 mgKOH/g, the flame retardant additive comprises aluminum diethyl phosphinate ranging from 20 wt. % to 60 wt. %, based on the total weight of the composition, the coating composition has a UL rating of VTM-0, and wherein the coating composition has a haze value of less 20%.

In some embodiments, the present disclosure relates to a flame retardant label comprising: a coating layer comprising a base polymer having a hydroxyl value greater than 100 mgKOH/g, a crosslinker comprising an isocyanate compound; and a flame retardant additive comprising a phosphinate compound; a film layer; and an adhesive layer, comprising a second base polymer, a second flame retardant agent, a tackifier, and a second crosslinker. In some cases, the coating layer is a topcoat layer. In some cases, the coating layer is a primer layer. In some cases, the second base polymer comprises a polyester, polyacrylate, or combinations thereof, wherein the second base polymer has a hydroxyl value less than 100 mgKOH/g, wherein the second crosslinker comprises isocyanate, epoxy, or combinations thereof. In some cases, the weight ratio of the tackifier in the adhesive layer to the second base polymer is from 1:10 to 1.5:1.

In some embodiments, the present disclosure relates to a method for forming a flame-resistant label, the method comprising: providing a substrate; applying a coating composition to the substrate, the coating composition comprising: a polymer having a hydroxyl value greater than 100 mgKOH/g; a crosslinker comprising an isocyanate compound; a flame retardant additive comprising a phosphinate compound; and curing the coating composition.

### DETAILED DESCRIPTION

### Introduction

Labels for electrical equipment, e.g., a battery, must be flame retardant for protection against fire hazards. However, adding flame retardants to layers of a label, e.g., a topcoat or a primer, may compromise properties that are very important for the intended function, such as, adhesion and optical performance. For example, adding flame retardants may decrease the shear strength of the label, which may cause the label to be brittle and difficult to be cut into small labels. Additionally, adding flame retardants to the adhesive layer may also cause a decrease in the label's adhesion power and tack strength. Also, adding flame retardants to the layers of a label may decrease the transparency of the label resulting in an opaque label.

The inventors have found that a unique combination of components in a coating composition, e.g., a topcoat and/or a primer, provides for a composition, e.g., a layer, that demonstrates superior flame-retardant properties as well as good strength and transparency. It has now been discovered that, to minimize the negative effect of the presence of flame retardant additives on the optical properties of the label, in some cases, a high hydroxyl value polymer and a flame retardant additive comprising a phosphinate compound may be employed as components of the coating composition. Without being bound by theory, it is postulated that some of the hydroxy groups of the polymer complex with some of the phosphinate compounds to form a hydroxy-phosphinate complex. The combination of the high-hydroxyl value polymer and the phosphinate flame retardant additive forms hydroxy-phosphinate complexes that improve flame-retardant properties. The coating composition surprisingly exhibits a haze value of less than 20% and has a UL94 rating of VTM-0.

Additionally, it was found that utilizing a coating composition including flame retardant additives having an average particle size less than 2 microns in the coating composition produces a flame retardant label, e.g., in compliance with UL94 VTM-0 standard, without compromising other properties of the label such as printability and transparency. Without being bound by theory, it is believed that the amount of flame retardant additive in the coating composition, as well as the average particle size of the flame retardant additive, produces a smooth coating layer with no visible particles that would otherwise negatively affect optical properties of the label.

The inventors of the application have also discovered that the use of specific concentration ranges for the components described herein provide for a desirable combination of performance characteristics. It was found that crosslinking a high-hydroxyl value polyester or polyacrylate with an isocyanate system effectively crosslinks the hydroxyl groups of the polymer which beneficially reduces haze and improves optical clarity. This reduction in haze in the topcoat and/or primer results in an optically clear, transparent layer. As used in all embodiments herein, the term “optically clear” refers to the clarity of the coating composition when applied a substrate as measured by haze value.

In some embodiments, the coating composition is applied on a substrate, e.g., a film layer or an adhesive layer, to provide a topcoat layer that improves the flame retardancy and optical characteristics of a label. Optionally, the label comprises a printable layer and a liner. In some embodiments, the topcoat layer, the film layer, and the adhesive layer are arranged in the order from top to bottom, from the perspective of looking downward to the substrate to be labeled. Stated another way, the film layer may be configured between the topcoat layer and the adhesive layer. Other layers may also be present between the topcoat layer and the adhesive layer. Optionally, the label comprises a primer layer between the film layer and the adhesive layer, e.g., on the opposing side of the topcoat layer. In some embodiments, each of the topcoat layer, the film layer, the adhesive layer have opposing top and bottom surfaces, with the bottom surface being the surface that faces the substrate.

In some embodiments, the coating composition is applied on a substrate, e.g., a film layer or an adhesive layer, to provide a primer layer that improves the flame retardancy and optical characteristics of a label. Optionally, the label comprises a printable layer and a liner. In some embodiments, the film layer, the primer layer, and the adhesive layer are arranged in the order from top to bottom, from the perspective of looking downward to the substrate to be labeled. Stated another way, the primer layer may be configured between the film and the adhesive layer. Other layers may also be present between the topcoat layer and the adhesive layer. Optionally, the label comprises a topcoat layer directly adjacent to the film layer, e.g., on the opposing side of the primer layer.

### Coating Composition

In some embodiments, the coating composition comprises a (first) base polymer, a (first) crosslinker, and a (first) flame retardant additive. In some embodiments, the coating composition may further include the optional additives listed below.

The composition of base polymer may vary widely, and any suitable polymer may be used, provided the characteristics described herein are satisfied. In some embodiments, the base polymer comprises a polyester, polyacrylate, or combinations thereof. In some embodiments, the base polymer of the coating composition may be a polyester polyol, e.g., a hydroxylated polyester polyol. In some cases, the base polymer may comprise a polyacrylate polyol, e.g., a hydroxylated polyester polyol. In some cases, the base polymer may be an acrylic modified saturated polyester polyol resin, a polyacrylate polyol, or combinations thereof.

Examples of suitable commercially available polyester polyols that may be used as the first base polymer include Hypomer PE-8043 by ELEMENTIS, Uralac® SC953, Uralac® SN862, Uralac® SY942, Uralac® SY941, Uralac® SY944 by DSM. Desmophen® 1300PR, Desmophen® 1400PR, Desmophen® PL302, Desmophen® 817, Desmophen® RD181, Desmophen® 650, Desmophen®651, Desmophen® 670, Desmophen® 800, Desmophen® 850, Desmophen®1100, Desmophen® 1145, Desmophen®1150, Desmophen® 1155, Desmophen® 1200, Desmophen® 1300 by COVESTRO. Capa® 2043, Capa® 2054, Capa®2085, Capa® 3050, Capa® 3091, Capa® 4101 by PERSTORP. Synolac 680X60 by ARKEMA.

Suitable hydroxylated polyester commercial products may also include polymerized copolyester resins such as VYLON 103, VYLON 200, VYLON 220, VYLON 240, VYLON 270, VYLON 300, VYLON 500, VYLON 226, VYLON 670, and VYLON 550 (all commercially available from TOYOBO®). Additional exemplary hydroxylated polyester commercial products include high-molecular weight and medium-molecular weight copolyesters, e.g., molecular weight ranging from about 2,000 grams per mole to about 20,000 grams per mole, such as DYNAPOL L912, DYNAPOL L952, DYNAPOL L206, DYNAPOL L205, DYNAPOL L208, DYNAPOL L210, DYNAPOL L411, DYNAPOL L850, DYNAPOL L658, DYNAPOL LH815, DYNAPOL LH830, DYNAPOL LH828, and DYNAPOL LH744 (all commercially available from Evonik Degussa).

In some embodiments, the base polymer may comprise polyacrylates, polyacrylics, polyacrylamides, polymethacrylates, polymethacrylics, or polymethacrylamides. These resins includes those derived from acrylic acid, acrylate esters, acrylamide, methacrylic acid, methacrylate esters, and methacrylamide. In some embodiments, the base polymer generally contains from 1 to about 30 carbon atoms in the pendant group, or from 1 to about 18, or from 2 to about 12 carbon atoms in the pendant group.

Examples of suitable commercially available polyacrylate polyols that may be used as the first base polymer include Hypomer FS-2970, Hypomer FS-2820, Hypomer FS-3060, Hypomer FS-3270, Hypomer FS-4365A, Hypomer FS-4470, Hypomer FS-4660P by ELEMENTIS. Uralac® CY250, Uralac® CY240, HY Hybrane™ CY245, Hybrane™ CY235 by DSM. Desmophen® A665, Desmophen® A870 from COVESTRO. Synocure 865 EEP 70, Synocure 9237, Synocure 866, Synocure 9201, Synocure 570 X65, and Synocure 9279 S70 by ARKEMA.

Examples of commercial polyacrylates and polymethacryls include Gelva® 2497 (commercially available from Monsanto Co., St. Louis, Mo.), Duraplus® 2 (commercially available from Rohm & Haas Co., Philadelphia, Pa.), Joncryl® 95 (commercially available from S. C. Johnson Polymer, Sturtevant, Wis.), SCX-1537 (S. C. Johnson Polymer), SCX-1959 (S. C. Johnson Polymer), SCX-1965 (S. C. Johnson Polymer), Joncryl® 530 (S. C. Johnson Polymer), Joncryl® 537 (S. C. Johnson Polymer), Glascol LS20 (commercially available from Allied Colloids, Suffolk, Va.), Glascol C37 (Allied Colloids), Glascol LS26 (Allied Colloids), Glascol LS24 (Allied Colloids), Glascol LE45 (Allied Colloids), Carboset® CR760 (commercially available from BFGoodrich, Cleveland, Ohio), Carboset® CR761 (BFGoodrich), Carboset® CR763 (BFGoodrich), Carboset® 765 (BFGoodrich), Carboset® 19X2 (BFGoodrich), Carboset® XL28 (BFGoodrich), Hycar 26084 (BFGoodrich), Hycar 26091 (BFGoodrich), Carbobond 26373 (BFGoodrich), Neocryl® A-601 (commercially available from Avecia Resins, Wilmington, Mass.)Neocryl® A-612 (Avecia Resins), Neocryl® A-6044 (Avecia Resins), Neocryl® A-622 (Avecia Resins), Neocryl® A-623 (Avecia Resins), Neocryl® A-634 (Avecia Resins), and Neocryl® A-640 (Avecia Resins).

In some aspects, the polyacrylate can be formed by any means known in that art. Suitable polyacrylates include, for example, copolymers of one or more alkyl esters of acrylic acid or methacrylic acid, optionally together with one or more other polymerizable ethylenically unsaturated monomers. Suitable alkyl esters of acrylic acid or methacrylic acid include, without limitation, methyl methacrylate, ethyl methacrylate, butyl methacrylate, ethyl acrylate, butyl acrylate, and 2-ethyl hexyl acrylate. Suitable other copolymerizable ethylenically unsaturated monomers include nitrites, such as acrylonitrile and methacrylonitrile, vinyl and vinylidene halides, such as vinyl chloride and vinylidene fluoride, and vinyl esters, such as vinyl acetate, among other monomers. Acid and anhydride functional ethylenically unsaturated monomers, such as acrylic acid, methacrylic acid or anhydride, itaconic acid, maleic acid or anhydride, or fumaric acid may be used. Amide functional monomers including, without limitation, acrylamide, methacrylamide, and N-alkyl substituted (meth)acrylamides are also suitable. Vinyl aromatic compounds, such as styrene and vinyl toluene, can also be used in certain cases.

Functional groups, such as hydroxyl and amino groups, can be incorporated into the acrylic polymer by using functional monomers, such as hydroxyalkyl acrylates and methacrylates or aminoalkyl acrylates and methacrylates. Epoxide functional groups (for conversion to cationic salt groups) may be incorporated into the acrylic polymer by using functional monomers, such as glycidyl acrylate and methacrylate, 3,4-epoxycyclohexylmethyl(meth)acrylate, 2-(3,4-epoxycyclohexyl)ethyl(meth)acrylate, or allyl glycidyl ether. Alternatively, epoxide functional groups may be incorporated into the acrylic polymer by reacting carboxyl groups on the acrylic polymer with an epihalohydrin or dihalohydrin, such as epichlorohydrin or dichlorohydrin.

In some embodiments, the first base polymer comprises hydroxyl functional groups. The inventors have surprisingly found that hydroxyl functional groups can beneficially interact, e.g., form a complex, with the first flame retardant agent, thereby improving the flame retardant capabilities of the label. The presence of hydroxyl functional groups in a polymer can be quantified by the polymer's hydroxyl value, which is the amount of potassium hydroxide required to neutralize the acetic acid taken up on acetylation of one gram of a polymer that contains free hydroxyl groups.

In some embodiments, the base polymer may have a hydroxyl value ranging from 100 mgKOH/g to 350 mgKOH/g, e.g., from 105 mgKOH/g to 325 mgKOH/g, from 110 mgKOH/g to 300 mgKOH/g, from 115 mgKOH/g to 290 mgKOH/g, from 120 mgKOH/g to 280 mgKOH/g, from 130 mgKOH/g to 270 mgKOH/g, from 140 mgKOH/g to 260 mgKOH/g, from 150 mgKOH/g to 250 mgKOH/g, from 160 mgKOH/g to 240 mgKOH/g, from 170 mgKOH/g to 230 mgKOH/g, from 180 mgKOH/g to 220 mgKOH/g, from 190 mgKOH/g to 210 mgKOH/g, or from 200 mgKOH/g to 205 mgKOH/g. In some embodiments, the base polymer may have a hydroxyl value greater than 100 mgKOH/g, e.g., greater than 105 mgKOH/g, greater than 110 mgKOH/g, greater than 115 mgKOH/g, greater than 120 mgKOH/g, greater than 125 mgKOH/g, greater than 130 mgKOH/g, greater than 135 mgKOH/g, greater than 140 mgKOH/g, greater than 145 mgKOH/g, greater than 150 mgKOH/g, greater than 155 mgKOH/g, greater than 160 mgKOH/g, greater than 165 mgKOH/g, greater than 170 mgKOH/g, greater than 175 mgKOH/g, greater than 180 mgKOH/g, greater than 185 mgKOH/g, greater than 190 mgKOH/g, or greater than 195 mgKOH/g. In terms of upper limits, the base polymer has a hydroxyl value less than 350 mgKOH/g, e.g., less than 325 mgKOH/g, less than 300 mgKOH/g, less than 290 mgKOH/g, less than 280 mgKOH/g, less than 275 mgKOH/g, less than 270 mgKOH/g, less than 265 mgKOH/g, less than 260 mgKOH/g, less than 255 mgKOH/g, less than 250 mgKOH/g, less than 245 mgKOH/g, less than 240 mgKOH/g, less than 235 mgKOH/g, less than 230 mgKOH/g, less than 225 mgKOH/g, less than 220 mgKOH/g, less than 215 mgKOH/g, less than 210 mgKOH/g, less than 205 mgKOH/g, or less than 195 mgKOH/g.

The wt. % of the coating composition is provided on a dry-basis, e.g., absent any solvent-based additives.

In one embodiment, the coating composition contains from 20 to 60 wt. % of the first base polymer, based on the total weight of the coating layer, e.g., from 25 to 60 wt. %, from 30 to 60 wt. %, from 35 to 60 wt. %, from 20 to 55 wt. %, from 25 to 55 wt. %, from 30 to 55 wt. %, from 35 to 55 wt. %, from 20 to 50 wt. %, from 25 to 50 wt. %, from 30 to 50 wt. %, from 35 to 50 wt. %, from 20 to 45 wt. %, from 25 to 45 wt. %, from 30 to 45 wt. %, or from 35 to 45 wt. %. In terms of lower limits, in some embodiments of the flame retardant label, the coating layer may comprise greater than 20 wt. % of the first base polymer, e.g., greater than 25 wt. %, greater than 30 wt. %, or greater than 35 wt. %, based on the total weight of the coating layer. In terms of upper limits, in some embodiments of the flame retardant label, the coating layer may comprise less than 60 wt. %. of the first base polymer, e.g., less than 55 wt. %., less than 50 wt. %, or less than 45 wt. %. The amount of the first base polymer may be chosen based on the desired stiffness of the coating layer, the amount of flame retardant agent present in the coating layer, and/or the ability to provide sufficient anchorage of the coating layer on the film layer. In general, a lower weight percentage of the first base polymer and/or a higher weight percentage amount of flame retardant is correlated with a more stiff flame retardant label. The stiffness of the label may affect the performance characteristics or usability of the label, e.g., the capability of being slit into small labels of suitable shapes and sizes.

In some aspects, the coating composition comprises a crosslinker, and the high hydroxyl value polymer may be crosslinked with the crosslinker. In general, a crosslinker is a substance that forms a crosslink between polymer chains, e.g., by bonding to each polymer chain. Typically, the addition of a crosslinker increases stiffness or rigidity. For example, the crosslinker can be utilized to crosslink the functional groups of a polymer, e.g., a high hydroxyl value polymer. Preferably, the crosslinkers react with functional groups, e.g., hydroxyl functional groups, of the base polymer. In some embodiments, the coating layer comprises an isocyanate crosslinker. For example, in some embodiments, the first crosslinker comprises aromatic isocyanates, aliphatic isocyanates, aromatic di-isocyanates, aliphatic di-isocyanates, aromatic polyisocyanates, or aliphatic polyisocyanates, or combinations thereof.

Examples of suitable commercially available products that may be used as the first crosslinker include Desmodur N 75A BA, Desmodur N 75A BA/X, Desmodur N 100A, Desmodur N 3200, Desmodur N 3300A, Desmodur N 3390A BA/SN, Desmodur N 3600, Desmodur N 3580, Desmodur N 3790 BA, Desmodur PL 3800, Desmodur N 3900, Desmodur PL 340 BA/SN, Desmodur NZ1, Desmodur E3265, Desmodur E3370, Desmodur PL 350 MPA/SN, Desmodur TS 35, Desmodur TS 50, Desmodur VL, Desmodur VP LS 2078/2, Desmodur VP LS 2371, Desmodur VP LS 2397, Desmodur VP. PU ME 28TF04, Desmodur VP. PU MS 30TF01, Desmodur W, Desmodur XP 2410, Desmodur XP 2500, Desmodur XP 2580, Desmodur XP 2565, Desmodur XP 2489, Desmodur XP 2565, Desmodur XP 2599, Desmodur XP 2617, Desmodur XP 2675, Desmodur XP 2763, Desmodur XP 2795, Desmodur XP 2838, Desmodur XP 2840, Desmodur Z 4470 BA, Desmodur Z 4470 MPA/X, Desmodur Z 4470 SN, Desmodur Z 4470 SN/BA, Desmodur IL 1351, Desmodur LD, Desmodur LP BUEJ 471, Mondur 445, Mondur 448 by COVESTRO (formerly Bayer Material Sciences). Basonat HA 100, Basonat HA 200, Basonat HA 300, Lupranat M10R, Lupranat M20FB, Lupranat M205, Lupranat M50, Lupranat M70R, Lupranat ME, Lupranat MI, Lupranat MM103, Lupranat MP102, Lupranat MP105, Lupranat MR, Lupranat T80A by BASF, Isonate 50 O, Isonate 125 M, Isonate 143 L, Isonate 181, Isonate 240, PAPI 20, PAPI 27, PAPI 94, PAPI 95, PAPI 580N, and PAPI 901 by DOW CHEMICAL. Takenate 500, Takenate 600, Takenate 700, Takenate D110N, Takenate D120N, Takenate D131N, Takenate D140N, Takenate D160N, Takenate D165N, Takenate D170N, Takenate D178N, Stabio D3725N by MITSUI CHEMICALS.

In some embodiments, the coating layer contains from 10 to 30 wt. % of the first crosslinker, based on the total weight of the coating layer, e.g., from 10 to 28 wt. %, from 10 to 25 wt. %, from 10 to 22 wt. %, from 12 to 30 wt. %., from 12 to 28 wt. %, from 12 to 25 wt. %, from 12 to 22 wt. %, from 15 to 30 wt. %., from 15 to 28 wt. %, from 15 to 25 wt. %, from 15 to 22 wt. %, from 18 to 30 wt. %., from 18 to 28 wt. %, from 18 to 25 wt. %, from 18 to 22 wt. %, from 20 to 30 wt. %., from 20 to 28 wt. %, from 20 to 25 wt. %, or from 20 to 22 wt. %. In terms of lower limits, the coating layer may contain greater than 10 wt. %. of the first crosslinker, based on the total weight of the coating layer, e.g., greater than 12 wt. %., greater than 15 wt. %, greater than 18 wt. %., or greater than 20 wt. %. In terms of upper limits, the coating layer may contain less than 30 wt. %. of the first crosslinker, based on the total weight of the coating layer, e.g., less than 28 wt. %., less than 25 wt. %, or less than 22 wt. %.

As mentioned above, it has now been discovered that utilizing a high-hydroxyl value base polymer in combination with a crosslinker in a specific amount provides for unexpected performance properties of the resultant coating composition. For example, the cross-linked polymer may produce a topcoat that may be optically clear and transparent.

In some aspects, the high-hydroxyl value base polymer is crosslinked in solution, e.g., in the presence of water. In some aspects, the topcoat is a solvent-based topcoat formed from a solution comprising a high-hydroxyl value base polymer, a crosslinker, a flame-retardant additive and a solvent, e.g., water. Regardless of crosslinking, the solution may have a pH of at least 4, e.g., at least 4.25, at least 4.5, or at least 4.75. In terms of upper limits, the solution may have a pH of less than 7, e.g., less than 6.75, less than 6.5, less than 6.25, or less than 6. In terms of ranges, the solution may have a pH from 4 to 7, e.g., from 4.25 to 6.75, from 4.5 to 6.5, from 4.75 to 6.25, or from 4.75 to 6. The solids content of the solution may be at least 25%, e.g., at least 27.5%, at least 30%, or at least 35%. In terms of upper limits, the solids content of the solution may be less than 55%, e.g., less than 50%, less than 47.5%, or less than 45%. In terms of ranges the solids content of the solution may range from 25 to 55%, e.g., from 27.5 to 50%, from 30 to 47.5%, or from 35 to 45%. The solution may also comprise further components as described herein, including a crosslinker.

The amount of base polymer in the topcoat composition may be chosen based on the desired opacity of the topcoat. In some cases, the ratio of the amount of base polymer to the crosslinker in the topcoat composition may range from 10:1 to 0.1:1, e.g., from 8:1 to 0.2:1, from 6:1 to 0.25:1, from 5:1 to 0.33:1, from 3:1 to 0.25:1, from 2:1 to 0.5:1, or from 1.5:1 to 1:1. In terms of upper limits, the ratio of the amount of base polymer to the crosslinker in the topcoat composition is less than 10:1, e.g., less than 9:1, less than 8:1, less than 7:1, less than 6:1, or less than 5:1. In terms of lower limits, the ratio of the amount of base polymer to the crosslinker in the topcoat composition is greater than 0.1:1, e.g., greater than 0.25:1, greater than 0.5:1, greater than 0.6:1, greater than 0.8:1, greater than 0.9:1, or greater than 1:1. The inventors have found that by keeping the ratio of base polymer to crosslinker within these ranges, the topcoat has the beneficial combination of features of good adhesion for printing performance and is transparent.

As noted above, the coating composition may comprise a flame retardant additive. The composition of the first flame retardant additive may vary widely, and any conventional flame retardant may be used, provided the characteristics described herein are satisfied. In some embodiments, the flame retardant additive comprises one or more organic phosphinates. For example, the flame retardant additive may comprise metallic salts of organic phosphinates, e.g., salts of organic phosphinates comprising magnesium, calcium, aluminum, antimony, tin, titanium, zinc, or iron. In some embodiments, the flame retardant additive may comprise organic diphosphinates. In some cases, the first flame retardant agent is an aluminum salt of an organic disphosphinate. The flame retardant additive in the coating composition can be in a form of particles.

Non-limiting examples of flame-retardant agents include metal alkyl phosphinates, melamine based flame retardants; organophosphorus flame retardants; metal oxide hydrates, such as magnesium hydroxide hydrates, aluminum oxide hydrates; polysiloxanes; phosphates such as ammonium polyphosphates and aryl phosphates; ammonium polyphosphates, metal alkyl phosphinates; and mixtures thereof. In some cases, the flame retardant used for this layer or any other layer of the label is a halogen-free flame retardant, i.e., free of chlorine and bromine.

In some embodiments, the flame retardant is selected from the group consisting of metal alkyl phosphinates (e.g., Exolit OP 935), metal hydroxides (e.g., Al(OH)₃), and mixtures thereof. In some embodiments, the weight ratio between the metal alkyl phosphinates and the metal hydroxide in the flame retardant can be a ratio ranging from 1:2 to 2:1, for example, about 1:1. Examples of suitable commercially available products that may be used as the flame retardant additive include the Exolit® OP series by Clariant.

In one embodiment, the coating composition contains from 20 to 60 wt. % of the flame retardant additive, based on the total weight of the coating composition, e.g., from 25 to 60 wt. %, from 30 to 60 wt. %, from 35 to 60 wt. %, from 20 to 55 wt. %, from 25 to 55 wt. %, from 30 to 55 wt. %, from 35 to 55 wt. %, from 20 to 50 wt. %, from 25 to 50 wt. %, from 30 to 50 wt. %, from 35 to 50 wt. %, from 20 to 45 wt. %, from 25 to 45 wt. %, from 30 to 45 wt. %, or from 35 to 45 wt. %. In terms of lower limits, in some embodiments of the flame retardant label, the coating composition may comprise greater than 20 wt. % of the first flame retardant additive, e.g., greater than 25 wt. %, greater than 30 wt. %, or greater than 35 wt. %, based on the total weight of the coating layer. In terms of upper limits, in some embodiments of the flame retardant label, the coating composition may comprise less than 60 wt. %. of the first flame retardant additive, e.g., less than 55 wt. %., less than 50 wt. %, or less than 45 wt. %.

It was surprisingly found that the combination of the high-hydroxyl value polymer and the phosphinate flame retardant additive forms hydroxy-phosphinate complexes that improve flame-retardant properties. In some cases, the coating composition comprises hydroxy-phosphinate complex ranging from 20 wt. % to 60 wt. %, based on the total weight of the coating composition, e.g., from 25 to 60 wt. %, from 30 to 60 wt. %, from 35 to 60 wt. %, from 20 to 55 wt. %, from 25 to 55 wt. %, from 30 to 55 wt. %, from 35 to 55 wt. %, from 20 to 50 wt. %, from 25 to 50 wt. %, from 30 to 50 wt. %, from 35 to 50 wt. %, from 20 to 45 wt. %, from 25 to 45 wt. %, from 30 to 45 wt. %, or from 35 to 45 wt. %. In terms of lower limits, in some embodiments of the flame retardant label, the coating composition may comprise greater than 20 wt. % of the hydroxy-phosphinate complexes, based on the total weight of the coating composition, e.g., greater than 25 wt. %, greater than 30 wt. %, or greater than 35 wt. %, based on the total weight of the coating layer. In terms of upper limits, in some embodiments of the flame retardant label, the coating composition may comprise less than 60 wt. % of the hydroxy-phosphinate complexes, based on the total weight of the coating composition, e.g., less than 55 wt. %., less than 50 wt. %, or less than 45 wt. %.

In some aspects, utilizing flame retardant additives having a specific average particle size in the coating composition may also contribute to forming a layer, e.g., topcoat layer or primer layer, that is optically clear and transparent. In particular, flame-retardant additives having an average particle size, e.g., D₅₀, less than 2 microns provided for a layer that minimizes the negative effect of the presence of flame retardant additives on the optical properties of the label.

In some embodiments, the coating composition includes a flame retardant additive having an average particle size (D₅₀) ranging from 0.01 microns to 2 microns, e.g., from 0.02 microns to 1.8 microns, from 0.04 microns to 1.6 microns, from 0.06 microns to 1.4 microns, from 0.08 microns to 1.2 microns, from 0.9 microns to 1.1 microns, or from 0.2 microns to 1 microns. In terms of upper limits, the coating composition includes a flame retardant additive having an average particle size less than 2 microns, e.g., less than 1.8 microns, less than 1.6 microns, less than 1.4 microns, less than 1.2 microns, or less than 1 microns. In terms of upper limits, the coating composition includes a flame retardant additive having an average particle size greater than 0.01 microns, e.g., greater than 0.02 microns, greater than 0.04 microns, greater than 0.06 microns, greater than 0.08 microns, greater than 0.1 microns, greater than 0.2 microns, or greater than 0.4 microns.

The amount of flame retardant in the coating composition may be chosen based on the desired flame retardancy and the stiffness of the label; a higher amount of flame retardant increase flame retardancy but could also increase the stiffness of the label. Thus, to confer the appropriate flame retardancy and stiffness to the label, it is desirable to control both the amount of flame retardant and amount of resin within appropriate ranges, as described above. The flame retardant can be dispersed throughout the coating composition, or any other part of the label, in any fashion, e.g., homogenously or nonhomogeneously.

The thickness or the coating weight of the coating composition, when applied to a substrate, may vary widely. In some embodiments, the topcoat layer has a coating weight from 1 grams per square meter (gsm) to 50 gsm, e.g., 2 gsm to 45 gsm, 3 gsm to 40 gsm, 4 gsm to 35 gsm, 5 gsm to 30 gsm, 10 gsm to 20 gsm, or 10 gsm to 15 gsm. In terms of upper limits, the topcoat layer may have a coating weight of less than 50 gsm, e.g., less than 45 gsm, less than 40 gsm, less than 35 gsm, less than 30 gsm, less than 25 gsm, or less than 20 gsm. In terms of lower limits, the topcoat layer may have a coating weight greater than 1 gsm, e.g., greater than 2 gsm, greater than 3 gsm, greater than 4 gsm, greater than 5 gsm, greater than 6 gsm, greater than 8 gsm, or greater than 10 gsm.

The thickness of the coating composition, when applied as a layer to a substrate, may also vary. In some embodiments, the coating layer has a thickness ranging from 1 to 50 microns, e.g., 2 microns to 45 microns, 3 microns to 40 microns, 4 microns to 35 microns, 5 microns to 30 microns, 10 microns to 20 microns, or 10 microns to 15 microns. In terms of upper limits, the coating layer may have a thickness of less than 50 microns, e.g., less than 45 microns, less than 40 microns, less than 35 microns, less than 30 microns, less than 25 microns, or less than 20 microns. In terms of lower limits, the coating layer may have a thickness of greater than 1 micron, e.g., greater than 2 microns, greater than 4 microns, greater than 5 microns, or greater than 10 microns.

The thickness or coating weight of the topcoat layer may be chosen based on the desired stiffness of the topcoat on balance of the amount of flame retardant present in the topcoat layer—if the layer comprises lower percentage of flame retardant, it can be thinner or can have a lower coating weight; and if the layer comprises a higher percentage of flame retardant, it may require a thicker layer in order to maintain the optimal performance of the label, e.g., good adhesion, converting, and reposition performance.

In some embodiments, the coating composition may comprise a film forming material which may be cast as a solvent-based coating or in one embodiment may be an extrudable film forming material. In some embodiments, the solvent may be an organic-based solvent, such as a ketone, ester, aliphatic compound, aromatic compound, alcohol, glycol, glycol ether, etc. These include methylethyl ketone, methylisobutyl ketone, ethyl acetate, white spirits, alkanes, cycloalkanes, benzene, hydrocarbon substituted aromatic compounds (e.g., toluene, the xylenes, etc.), isoparaffinic solvents, and combinations of two or more thereof. Alternatively, water or a water-based solution may be used to form an aqueous emulsion. Water-based solutions include water-alcohol mixtures. The solvent or water is sufficiently volatile so that when applied to a substrate, the solvent evaporates leaving behind the coating composition, and any other additional non-volatile components.

### Additives

In some embodiments, the coating composition comprises one or more additional additives that may include wetting agents, leveling agents, dispersing agents, plasticizers, suspension aids, defoamers, and flow agents. The coating composition may optionally include one or more additives in amounts described herein. Such additives, for example, may be incorporated into the coating composition in conventional quantities using conventional equipment and techniques. For example, the coating composition may include one or more flow and/or leveling agents to mitigate the occurrence of any surface defects (e.g., formation of pinholes, cratering, peeling, scarring, blistering, air bubbles, etc.). Suitable flow and/or leveling agents utilized are those that do not interfere with desired loadings and/or physical or mechanical properties of the coating composition. In certain embodiments, for instance, several commercially available flow and/or leveling agents may be utilized, including, for example BYK-392 (solution of a polyacrylate); BYK-310 (solution of a polyester modified polydimethylsiloxane); BYK-3550 (siloxane-modified acrylic compound); from BYK Additives & Instruments; EFKA 3277 (fluorocarbon modified polyacrylate) from BASF; and/or EFKA 3740 (polyacrylate) from BASF.

In one embodiment, the coating composition includes from 0 to 5 wt. % of the flow and/or leveling agent, based on the total weight of the coating composition, e.g., from 0.01 to 8 wt. %, from 0.05 to 4 wt. %, from 0.08 to 3 wt. %, from 0.1 to 2 wt. %, from 0.15 to 1 wt. %, from 0.2 to 0.8 wt. %, from 0.25 to 0.5 wt. %, or from 0.3 to 0.4 wt. %. In terms of lower limits, in some embodiments of the flame retardant label, the coating composition may comprise greater than 0 wt. % of the flow and/or leveling agent, e.g., greater than 0.01 wt. %, greater than 0.05 wt. %, greater than 0.08 wt. % greater than 0.1 wt. %, or greater than 0.15 wt. %, based on the total weight of the coating layer. In terms of upper limits, in some embodiments of the flame retardant label, the coating composition may comprise less than 5 wt. %. of the flow and/or leveling agent, e.g., less than 4 wt. %., less than 3 wt. %, less than 2 wt. %, less than 1 wt. %, less than 0.5 wt. %, or less than 0.3 wt. %.

The coating composition may also include one or more dispersing agents. In some embodiments, the dispersing agent is a flame-retardant dispersing agent. For example, commercially available dispersing agents may be added to the coating composition to disperse flame-retardant additives in the coating composition. In certain embodiments, for instance, commercially available dispersing agents may be utilized, including, for example BYK-170 from BYK Additives & Instruments.

In one embodiment, the coating composition includes from 0 to 10 wt. % of the dispersing agent, based on the total weight of the coating composition, e.g., from 0.1 to 8 wt. %, from 0.5 to 6 wt. %, from 1 to 5 wt. %, from 2 to 4 wt. %, or from 2.5 to 3.5 wt. %. In terms of lower limits, in some embodiments of the flame retardant label, the coating composition may comprise greater than 0 wt. % of the dispersing agent, e.g., greater than 0.1 wt. %, greater than 0.5 wt. %, greater than 1 wt. % greater than 1.5 wt. %, or greater than 2 wt. %, based on the total weight of the coating layer. In terms of upper limits, in some embodiments of the flame retardant label, the coating composition may comprise less than 10 wt. %. of the dispersing agent, e.g., less than 9 wt. %., less than 8 wt. %, less than 7 wt. %, less than 6 wt. %, less than 5 wt. %, or less than 4 wt. %.

According to certain embodiments of the present invention, suitable catalyst may also be used. For instance, the constituents of the coating composition may include one or more acid catalysts, such as para-toluene sulfonic acid (PTSA) or methyl sulfonic acid (MSA). Useful acid catalysts may include, by way of example, boric acid, phosphoric acid, sulfate acid, hypochlorides, oxalic acid and ammonium salts thereof, sodium or barium ethyl sulfates, sulfonic acids, and similar acid catalysts. Other useful catalysts, according to certain embodiments, may include dodecyl benzene sulfonic acid (DDBSA), amine blocked alkane sulfonic acid (MCAT 12195), amine blocked dodecyl para-toluene sulfonic acid (BYK 460), and amine blocked dodecyl benezene sulfonic acid (Nacure 5543). In other embodiments, suitable catalysts include organo-iron compounds, zirconium complexes (e.g., K-KAT XC-923, K-KAT XC-4205, or K-KAT XC-6212), metal chelates (e.g., NACURE XC-9206), antimony-based catalysts (such as NACURE XC-7231), or bismuth catalysts (e.g., K-KAT 348), all of which are commercially available from King Industries, Inc.

The coating composition may also include one or more defoaming agents. A defoaming agent generally reduces or mitigates the formation of foaming in the topcoat layer when deposited or generally handled or transferred from one location to another. Generally, any defoaming agent that does not interfere in some embodiments, desired loadings and/or physical or mechanical properties of the coating composition may be used. For instance, the defoaming agent may be mineral-based, silicone-based, or non-silicone-based.

In accordance with certain embodiments, the coating composition may also include one or more antioxidants. Any suitable antioxidants for a particular embodiment may be used. In some embodiments, antioxidants may be selected that exhibit good heat resistance and mitigate the discoloration of polymeric-based articles/coatings. Exemplary antioxidants suitable for use according to certain embodiments include, but not limited to, CHINOX 626, CHINOX 625 (organophophite antioxidant), CHINOX 245 (steric hindered phenolic antioxidant), and CHINOX 30N (blend of hindered phenolic antioxidants), each of which is commercially available from Double Bond Chemical Ind., Co., Ltd.

The coating composition may also include one or more matting agents which may facilitate formation of a coating layer. Any suitable matting agent for a particular embodiment may be utilized. In some embodiments, the matting agents may have a small particle size. For example, in some embodiments, the matting agents may have a particle size of less than 10 microns on average, e.g., less than 5 microns on average, such as modified or surface treated silica. The silica may be treated a variety of organic polymers depending on the particular resin system employed in the topcoat layer. In certain embodiments, the matting agent may include untreated silicon dioxide.

### Topcoat and Primer Compositions

In some embodiments, the coating composition may be utilized in the form of a topcoat. When used as a topcoat, the coating composition may be applied to the top layer of a label that is directly exposed to the surrounding environment. From the perspective looking downwardly toward a substrate, in one embodiment, the topcoat may be the top layer of a label. For example, when coated on a substrate, the topcoat is configured directly adjacent a film layer, e.g., the topcoat layer is positioned above the film layer. The topcoat may serve as a surface that is marked with information, such as a barcode or alphanumeric characters, and may be flame retardant and transparent.

In some embodiments, the coating composition may be utilized in the form of a primer layer. From the perspective looking downwardly toward a substrate, in one embodiment, the primer layer may be the layer that is directly below a film layer. For example, when coated on a substrate, the primer is configured directly adjacent a film layer, e.g., the primer layer is positioned below the film layer. In some embodiments, the primer layer is on the opposite surface of the film layer from the topcoat, e.g., the film layer may be configured between the topcoat and the primer layer.

In some cases, optional additives described herein may be utilized with the topcoat or in the primer composition. In some embodiments, the composition of the topcoat is different from the composition of the primer, and vice versa. For example, the primer composition may comprise the same polyester and/or polyacrylate resin as the topcoat, the same crosslinkers, the same flame-retardant additives, but different additives as described herein. In some cases, the composition of the topcoat may be the same as the composition of the primer. In other cases, the primer composition may comprises a greater percentage of flame-retardant additives.

The coating composition as described herein may be applied onto a film layer, an adhesive layer, a printable layer, or combination thereof, by any known technique in the art such as spray, roll, brush, or other techniques. Exemplary labels and laminate structures are described in PCT Application No. PCT/CN2019/074558.

### Properties

In some embodiments, the coating compositions described herein may form an optically clear layer in a label construction. In some aspects, the haze value may be measured, for example, by ASTM D1003 (2018). In some embodiments, the coating composition may form a layer having a haze value ranging from 0% to 20%, e.g., from 1% to 19%, from 2% to 18%, from 3% to 17%, from 4% to 16%, from 5% to 15%, from 6% to 14%, from 7% to 13%, from 9% to 12%, or from 10% to 11%. In terms of upper limits, the coating composition may form a layer having a haze value of less than 20%, e.g., less than 19%, less than 18%, less than 17%, less than 16%, less than 15%, less than 14%, less than 13%, less than 12%, less than 11%, or less than 10%. In terms of lower limits, the coating composition may form a layer having a haze value greater than or equal to 0%, e.g., greater than 0%, greater than 1%, greater than 2%, greater than 3%, greater than 4%, greater than 5%, greater than 6%, greater than 7%, greater than 8%, or greater than 9%.

In some cases, the coating composition may form a layer having a haze value of about 10% or less. In some cases, the coating composition may form a layer that has a haze value of about 1% or less. In some cases, the coating composition may form a layer that has a haze value of about 0.5% or less.

The flame retardant label of the present disclosure meets the flame-retardant requirements under the UL94 VTM standards (2016). UL94 is a standard for determining the material's tendency to either extinguish or spread the flame once the specimen has been ignited. The test procedures for evaluating flame-retardant performance under the UL 94 VTM are well known, for example, as described in http://industries.ul.com/plastics-and-components/plastics/plastics-testing#u194. Typically, to evaluate the flame-retardant performance of the labels disclosed herein, at least one set of five specimens are tested. Each specimen is burned for 3 seconds. The burning source (“burner”) is then removed and the time from the removal to the time when the burning stops is recorded as T1. The specimen is then burned again for three minutes. The burning source is once again removed and the time from removal to the time when the second burning stops is recorded as T2. The VTM tests typically measure the flame retardant performance of a set of five specimen and the total flaming combustion time for each specimen; the total flaming combustion time for all 5 specimens of any set; the glowing combustion time for each specimen after second burner flame application; whether the glowing or flaming combustion of any specimen is up to holding clamp; whether the cotton placed below the sample is ignited by flaming drips from any specimen are observed and recorded.

Table 1 shows the requirement for the VTM-0, VTM-1, or VTM standard.

TABLE 1
UL94 VTM Standards

| VTM test parameter | VTM-0 | VTM-1 | | VTM-2 | |
|---|---|---|---|---|---|
| Total flaming combustion | ≤10 sec | ≤30 | sec | ≤30 | sec |
| time for each specimen | | | | | |
| (T1 + T2) | | | | | |
| Total flaming combustion | ≤50 sec | ≤250 | sec | ≤250 | sec |
| time for all 5 specimens | | | | | |
| of any set | | | | | |
| Glowing combustion for | ≤30 sec | ≤60 | sec | ≤60 | sec |
| each specimen after | | | | | |
| second burner flame | | | | | |
| application | | | | | |

| | | | |
|---|---|---|---|
| Glowing or flaming | NO | NO | NO |
| combustion of any | | | |
| specimen up to | | | |
| holding clamp | | | |
| Whether Cotton can be | NO | NO | YES |
| ignited by flaming | | | |
| drips from any specimen | | | |

In some embodiments, the flammability rating of the flame retardant label satisfies the requirements of UL 94 VTM-2 standard. In other embodiments, the flammability rating of the flame retardant label satisfies the requirements of UL 94 VTM-1 standard. In some embodiments the flammability rating of the flame retardant label satisfies the requirements of UL 94 VTM-0 standard.

In some cases, the coating compositions described herein form a layer that complies with UL 94 VTM-0 standard, i.e., the coating composition forms a layer that has excellent flame retardant property and is an environment-friendly product. UL94 VTM-0 is the test standard for flammability of thin plastic materials released by Underwriters Laboratories Inc.

In some embodiments, the coating composition has a UL rating of VTM-0. In some embodiments, the base polymer comprises a hydroxyl value greater than 100 mgKOH/g, wherein the flame retardant additive comprises aluminum diethyl phosphinate ranging from 20 wt. % to 60 wt. %, based on the total weight of the composition, and wherein the coating composition has a UL rating of VTM-0. In some embodiments, the base polymer comprises a hydroxyl value greater than 100 mgKOH/g, wherein the phosphinate compound comprises aluminum diethyl phosphinate having an average particle size distribution less than 2 microns, and wherein the coating composition has a haze value less than 20%. In some embodiments, the base polymer comprises a polyester or a polyacrylate having a hydroxyl value greater than 100 mgKOH/g, wherein the flame retardant additive comprises aluminum diethyl phosphinate ranging from 20 wt. % to 60 wt. %, based on the total weight of the composition, wherein the coating composition has a UL rating of VTM-0, and wherein the coating composition has a haze value of less 20%.

### Coating Layer

As described above, the coating composition may be coated, e.g., onto a substrate, as a topcoat layer or a primer layer in a flame-retardant label. In some embodiments, the flame-retardant label may comprise a coating layer, a film layer, an adhesive layer, and optionally a liner. In some embodiments, the label may comprise a topcoat layer, a film layer, and an adhesive layer. In some embodiments, the label may comprise a film layer, a primer layer, and an adhesive layer. In some embodiments, the label may comprise a topcoat layer, a film layer, a primer layer, and an adhesive layer.

In some embodiments, the coating composition is applied on a substrate, e.g., a film layer, to provide a topcoat layer that improves the flame retardancy and optical characteristics of a label. In some embodiments, the topcoat layer, the film layer, and the adhesive layer are arranged in the order from top to bottom, from the perspective of looking downward to the substrate to be labeled. Stated another way, the film layer may be configured between the topcoat layer and the adhesive layer. Optionally, the label comprises a primer layer between the film layer and the adhesive layer, e.g., on the opposing side of the topcoat layer.

In some embodiments, the coating composition is applied on a substrate, e.g., a film layer or an adhesive layer, to provide a primer layer that improves the flame retardancy and optical characteristics of a label. In some embodiments, the film layer, the primer layer, and the adhesive layer are arranged in the order from top to bottom, from the perspective of looking downward to the substrate to be labeled. Stated another way, the primer layer may be configured between the film layer and the adhesive layer. Optionally, the label comprises a topcoat layer directly adjacent to the film layer, e.g., on the opposing side of the primer layer.

In some embodiments, the label may comprise both a topcoat layer and a primer layer. In this embodiment, the primer layer may be on the opposite surface of the film layer from the topcoat layer, e.g., the film layer may be configured between the topcoat layer and the primer layer. In this embodiment, the primer layer may comprise the same composition as the topcoat. Additionally, when crosslinker is included in the primer layer, the hydroxyl group on the film layer with react with the crosslinker and thus the primer layer is chemically bonded to the film layer.

### Flame-Retardant Label

In some embodiments, the flame retardant label comprises at least one film layer. In some embodiments, the film layer is disposed between the coating layer, e.g., topcoat layer, and the adhesive layer. In some embodiments, at least a portion of the film layer is in contact with the coating layer. The film layer can be a polymeric film or a metal foil. Materials for the film layer may be resins selected from polyester, ABS, polyacrylate, polycarbonate (PC), polyamide, polyimide (PI), polyamidoimide, polyacetal, polyphenylene oxide (PPO), polysulfone, polyethersulfone (PES), polyphenylene sulfide, polyether ether ketone (PEEK), polyetherimide (PEl), metallized polyethylene terephthalate (PET), polyvinyl fluoride (PVF), polyethylene ether (PEE), fluorinated ethylene propylene (FEP), polyurethane (PUR), liquid crystal polymers (LCPs, class of aromatic polyester), polyvinylidene fluoride (PVDF), aramid fibers, DIALAMY, (polymer alloys), polyethylene naphthalate (PEN), ethylene/tetrafluoroethylene, (E/TFE), polyphenyl sulfone (PPSU) and polymers or polymer alloys containing one or more of these materials.

In some embodiments, the film is pure polyethylene terephthalate (PET) film which is non-flame retardant (e.g., no flame retardant additive added). In some embodiments, the flame retardancy of the film layer meets the VTM-2, VTM-1, or VTM-0 standard. In some cases, the film is a polyethylene terephthalate (PET) film. In some embodiments, the film meets the requirement of VTM-0, VTM-1, or VTM-2. In some embodiments, the film layer also contains a flame retardant. Any of the flame retardants, e.g., those suitable for use in the coating layer or the adhesive layer as described herein, can be used in the film layer. The flame retardant used in the film layer may or may not be the same as the flame retardant used in the other layers of the flame retardant label. In some embodiments, the film is a PET film. In some embodiments, the film is a VTM-0 PET film or a VTM-2 PET film. Various PET films are commercially available, for example, from Dupont Teijin Films' MELINEX® series, Mitsubishi's HOSTAPHAN® series, etc.

In some embodiments, the film layer has a thickness ranging from 10 to 60 μm, e.g., from 10 to 58 μm, from 10 to 55 μm, from 10 to 52 μm, from 10 to 50 μm, from 12 to 60 μm, from 12 to 58 μm, from 12 to 55 μm, from 12 to 52 μm, from 12 to 50 μm, from 15 to 60 μm, from 15 to 58 μm, from 15 to 55 μm, from 15 to 52 μm, from 15 to 50 μm, from 20 to 60 μm, from 20 to 58 μm, from 20 to 55 μm, from 20 to 52 μm, or from 20 to 50 μm. In terms of lower limits, the film layer may have a thickness of at least 10 μm, e.g., at least 12 μm, at least 15 μm, or at least 20 μm. In terms of upper limits, the film layer may have a thickness less than 60 μm, e.g., less than 58 μm, less than 55 μm, less than 52 μm, or less than 50 μm.

### Adhesive Layer

In some embodiments, the flame retardant label comprises an adhesive layer. In one embodiment, the adhesive layer of the flame retardant label comprises a second base polymer. The adhesive layer may further comprise a second flame retardant agent, a tackifier, and a second crosslinker. The composition of the second base polymer may vary widely, and any polymer may be used, provided the characteristics described herein are satisfied. In some embodiments, the second base polymer comprises a polyester or a polyacrylate, or combinations thereof. In some cases, the second base polymer comprises an acrylic resin. In some embodiments, the second base polymer may comprise a pressure sensitive adhesive, e.g., a hydroxyl group substituted acrylic polymer. Suitable pressure sensitive adhesives may include, for example, copolymers of alkyl acrylates that have a straight chain of from 4 to 12 carbon atoms and a minor proportion of a highly polar copolymerizable monomer such as acrylic acid. In some cases, the second base polymer may be an ultraviolet-curable pressure sensitive adhesive.

Examples of suitable commercially available products that may be used as the second base polymer include Duro-Tak® 80-115 A or Duro-Tak 4000 by National Starch, Chemical Co. or Aroset™ 1860-Z-45 by Ashland Specialty Chemical Company.

In some embodiments, the second base polymer comprises hydroxyl functional groups. As noted above, the presence of hydroxyl functional groups can be quantified by the polymer's hydroxyl value. In one embodiment, the second base polymer of the adhesive layer has a hydroxyl value less than 100 mgKOH/g, e.g., less than 95 mgKOH/g, less than 90 mgKOH/g, less than 85 mgKOH/g, or less than 80 mgKOH/g. In terms of lower limits, the second base polymer may have a hydroxyl value greater than 0 mgKOH/g, e.g., greater than 2 mgKOH/g, greater than 5 mgKOH/g, or greater than 10 mgKOH/g. In terms of ranges, the second base polymer may have a hydroxyl value from 0 to 100 mgKOH/g, e.g., from 0 to 95 mgKOH/g, from 0 to 90 mgKOH/g, from 0 to 85 mgKOH/g, from 0 to 80 mgKOH/g, from 2 to 100 mgKOH/g, from 2 to 95 mgKOH/g, from 2 to 90 mgKOH/g, from 2 to 85 mgKOH/g, from 2 to 80 mgKOH/g, from 5 to 100 mgKOH/g, from 5 to 95 mgKOH/g, from 5 to 90 mgKOH/g, from 5 to 85 mgKOH/g, from 5 to 80 mgKOH/g, from 10 to 100 mgKOH/g, from 10 to 95 mgKOH/g, from 10 to 90 mgKOH/g, from 10 to 85 mgKOH/g, or from 10 to 80 mgKOH/g.

In some embodiments, the second base polymer comprises acid functional groups, e.g., carboxylic acid functional groups. The presence of acid functional groups in a polymer can be quantified by the polymer's acid value, which is the amount of potassium hydroxide required to neutralize one gram of a polymer that contains acid groups. In one embodiment, the second base polymer of the adhesive layer has an acid value less than 100 mgKOH/g, e.g., less than 95 mgKOH/g, less than 90 mgKOH/g, less than 85 mgKOH/g, or less than 80 mgKOH/g. In terms of lower limits, the second base polymer may have an acid value greater than 0 mgKOH/g, e.g., greater than 2 mgKOH/g, greater than 5 mgKOH/g, or greater than 10 mgKOH/g. In terms of ranges, the second base polymer may have an acid value from 0 to 100 mgKOH/g, e.g., from 0 to 95 mgKOH/g, from 0 to 90 mgKOH/g, from 0 to 85 mgKOH/g, from 0 to 80 mgKOH/g, from 2 to 100 mgKOH/g, from 2 to 95 mgKOH/g, from 2 to 90 mgKOH/g, from 2 to 85 mgKOH/g, from 2 to 80 mgKOH/g, from 5 to 100 mgKOH/g, from 5 to 95 mgKOH/g, from 5 to 90 mgKOH/g, from 5 to 85 mgKOH/g, from 5 to 80 mgKOH/g, from 10 to 100 mgKOH/g, from 10 to 95 mgKOH/g, from 10 to 90 mgKOH/g, from 10 to 85 mgKOH/g, or from 10 to 80 mgKOH/g.

In some embodiments, the second base polymer has a glass transition temperature from −50 to 10° C., e.g., from −50 to 8° C., from −50 to 5° C., from −50 to 2° C., from −50 to 0° C., from −48 to 10° C., from −48 to 8° C., from −48 to 5° C., from −48 to 2° C., from −48 to 0° C., from −45 to 10° C., from −45 to 8° C., from −45 to 5° C., from −45 to 2° C., from −45 to 0° C., from −42 to 10° C., from −42 to 8° C., from −42 to 5° C., from −42 to 2° C., from −42 to 0° C., from −40 to 10° C., from −40 to 8° C., from −40 to 5° C., from −40 to 2° C., or from −40 to 0° C. In terms of lower limits, the second base polymer may have glass transition temperature greater than −50° C., e.g., greater than −48° C., greater than −45° C., greater than −42° C., or greater than −40° C. In terms of upper limits, the second base polymer may have a glass transition temperature less than 10° C., e.g., less than 8° C., less than 5° C., less than 2° C., or less than 0° C.

In one embodiment, the adhesive layer contains from 50 to 100 wt. % of the second base polymer, based on the total weight of the adhesive layer, e.g., from 55 to 100 wt. %, from 60 to 100 wt. %, from 65 to 100 wt. %, from 50 to 95 wt. %, from 55 to 95 wt. %, from 60 to 95 wt. %, from 65 to 95 wt. %, from 50 to 90 wt. %, from 55 to 90 wt. %, from 60 to 90 wt. %, from 65 to 90 wt. %, from 50 to 85 wt. %, from 55 to 85 wt. %, from 60 to 85 wt. %, or from 65 to 85 wt. %. In terms of lower limits, in some embodiments of the flame retardant label, the adhesive layer may comprise greater than 50 wt. % of the second base polymer, e.g., greater than 55 wt. %, greater than 60 wt. %, or greater than 65 wt. %, based on the total weight of the adhesive layer. In terms of upper limits, in some embodiments of the flame retardant label, the adhesive layer may comprise less than 100 wt. %. of the second base polymer, e.g., less than 95 wt. %., less than 90 wt. %, or less than 85 wt. %, based on the total weight of the adhesive layer.

In some embodiments, the adhesive layer may further comprise a tackifier. Generally, a tackifier is a chemical compound used to increase the tack, e.g., the stickiness, of the surface of an adhesives. The composition of the tackifier of the adhesive layer may vary widely, provided the characteristics disclosed herein are satisfied. In some embodiments, the tackifier may comprise a rosin, a rosin derivative, a terpene, a modified terpene, an aliphatic, cycloaliphatic, or aromatic resin, a hydrogenated hydrocarbon resin, a terpene-phenol resin, or derivatives thereof, or combinations thereof. In some cases, the tackifier is a rosin resin. In other cases, the tackifier is a combination of a rosin resin and a terpene resin.

In one embodiment, the tackifier of the adhesive layer has an average softening point that is less than 125° C., e.g., less than 120° C., less than 115° C., or less than 110° C. In terms up lower limits, the tackifier may have an average softening point that is greater than 50° C., e.g., greater than 55° C., greater than 60° C., greater than 65° C., or greater than 75° C. In terms of ranges, the tackifier may have an average softening point that is from 50 to 125° C., e.g., from 50 to 120° C., from 50 to 115° C., from 50 to 110° C., from 55 to 125° C., from 55 to 120° C., from 55 to 115° C., from 55 to 110° C., from 60 to 125° C., from 60 to 120° C., from 60 to 115° C., from 60 to 110° C., from 65 to 125° C., from 65 to 120° C., from 65 to 115° C., from 65 to 110° C., from 75 to 125° C., from 75 to 120° C., from 75 to 115° C., or from 75 to 110° C.

In one embodiment, the adhesive layer comprises from 5 to 60 wt. % of the tackifier, based on the total weight of the adhesive layer, e.g., from 5 to 55 wt. %, from 5 to 50 wt. %, from 5 to 40 wt. %, from 8 to 60 wt. %., from 8 to 55 wt. %, from 8 to 50 wt. %, from 8 to 40 wt. %, from 10 to 60 wt. %, from 10 to 55 wt. %, from 10 to 50 wt. %, from 10 to 40 wt. %, from 12 to 60 wt. %, from 12 to 55 wt. %, from 12 to 50 wt. %, from 12 to 40 wt. %, from 15 to 60 wt. %, from 15 to 55 wt. %, from 15 to 50 wt. %, or from 15 to 40 wt. %. In terms of lower limits, the adhesive layer may comprise greater than 5 wt. %. of the tackifier, e.g., greater than 8 wt. %, greater than 10 wt. %, greater than 12 wt. %, or greater than 15 wt. %, based on the total weight of the adhesive layer. In terms of upper limits, the adhesive layer may comprises less than 60 wt. %. of the tackifier, e.g., less than 60 wt. %, less than 55 wt. %, less than 50 wt. %, or less than 40 wt. %, based on the total weight of the adhesive layer.

The inventors have surprisingly and unexpectedly found that the relative content of the tackifier to the second base polymer affects the adhesion activity of the flame retardant label. In particular, maintaining a specific weight ratio of the tackifier to the second base polymer can ensure that the adhesion performance of the flame retardant label remains satisfactory despite the addition of a flame retardant agent. In one embodiment, the weight ratio of the tackifier in the adhesive layer to the second base polymer is from 1:10 to 1.5:1, e.g., from 1:5 to 1.5:1, from 3:10 to 1.5:1, from 2:5 to 1.5:1, from 1:2 to 1.5:1, from 1:10 to 1.4:1, from 1:5 to 1.4:1, from 3:10 to 1.4:1, from 2:5 to 1.4:1, from 1:2 to 1.4:1, from 1:10 to 1.3:1, from 1:5 to 1.3:1, from 3:10 to 1.3:1, from 2:5 to 1.3:1, from 1:2 to 1.3:1, from 1:10 to 1.2:1, from 1:5 to 1.2:1, from 3:10 to 1.2:1, from 2:5 to 1.2:1, from 1:2 to 1.2:1, from 1:10 to 1:1, from 1:5 to 1:1, from 3:10 to 1:1, from 2:5 to 1:1, or from 1:2 to 1:1. In terms of lower limits, the weight ratio of the tackifier to the second base polymer may be greater than 1:10, e.g., greater than 1:5, greater than 3:10, greater than 2:5, or greater than 1:2. In terms of upper limits, the weight ratio of the tackifier to the second base polymer may be less than 1.5:1, e.g. less than 1.4:1, less than 1.3:1, less than 1.2:1, or less than 1:1.

In some embodiments, the adhesive layer may also comprise a second crosslinker. Generally, crosslinkers differ in regard to crosslinker density and reaction rate. The inventors have surprisingly found that the selection of a second crosslinker, based on these parameters, beneficially affects the formation of channels in the adhesive layer, as discussed below. The composition of the second crosslinker may vary widely. For example, the second crosslinker may comprise an isocyanate compound, a dialdehyde, a metal chelate compound, a metal alkoxide, a metal salt, and mixtures thereof. In some cases, adhesive layer comprises an epoxy crosslinker.

In one embodiment, the adhesive layer contains from 0.1 to 5 wt. % of the second crosslinker, based on the total weight of the coating layer, e.g., from 0.1 to 4 wt. %, from 0.1 to 3 wt. %, from 0.1 to 2 wt. %, from 0.5 to 5 wt. %., from 0.5 to 4 wt. %, from 0.5 to 3 wt. %, from 0.5 to 2 wt. %, from 1 to 5 wt. %., from 1 to 4 wt. %, from 1 to 3 wt. %, from 1 to 2 wt. %, from 1.2 to 5 wt. %., from 1.2 to 4 wt. %, from 1.2 to 3 wt. %, from 1.2 to 2 wt. %, from 1.5 to 5 wt. %., from 1.5 to 4 wt. %, from 1.5 to 3 wt. %, or from 1.5 to 2 wt. %. In terms of lower limits, the adhesive layer may contain greater than 0.1 wt. %. of the second crosslinker, based on the total weight of the coating layer, e.g., greater than 0.5 wt. %., greater than 1 wt. %, greater than 1.2 wt. %., or greater than 1.5 wt. %. In terms of upper limits, the adhesive layer may contain less than 5 wt. %. of the second crosslinker, based on the total weight of the coating layer, e.g., less than 4 wt. %., less than 3 wt. %, or less than 2 wt. %.

The inventors have surprisingly and unexpectedly found that the relative content of the second crosslinker to the second base polymer affects the adhesion activity of the flame retardant label. In particular, maintaining a specific weight ratio of the second crosslinker to the second base polymer can ensure that the adhesion performance of the flame retardant label remains satisfactory despite the addition of a flame retardant agent. In one embodiment, the weight ratio of the second crosslinker in the adhesive layer to the second base polymer is from 1:100 to 15:100, e.g., from 1.5:100 to 15:100, from 2:100 to 15:100, from 2.5:100 to 15:100, from 3:100 to 15:100, from 1:100 to 12:100, from 1.5:100 to 12:100, from 2:100 to 12:100, from 2.5:100 to 12:100, from 3:100 to 12:100, from 1:100 to 10:100, from 1.5:100 to 10:100, from 2:100 to 10:100, from 2.5:100 to 10:100, from 3:100 to 10:100, from 1:100 to 8:100, from 1.5:100 to 8:100, from 2:100 to 8:100, from 2.5:100 to 8:100, from 3:100 to 8:100, from 1:100 to 5:100, from 1.5:100 to 5:100, from 2:100 to 5:100, from 2.5:100 to 5:100, or from 3:100 to 5:100. In terms of lower limits, the weight ratio of the second crosslinker to the second base polymer may be greater than 1:100, e.g., greater than 1.5:100, greater than 2:100, greater than 2.5:100, or greater than 3:100. In terms of upper limits, the weight ratio of the second crosslinker to the second base polymer may be less than 15:100, e.g. less than 12:100, less than 10:100, less than 8:100, or less than 5:100.

The adhesive layer may also comprise a second flame retardant agent. The composition of the second flame retardant agent may vary widely. In particular, any of the flame retardant agents suitable for use as the first flame retardant agent, described above, may be used as the second flame retardant agent, provided that other features of the flame retardant label discussed herein are met. The first flame retardant agent of the coating layer may or may not be the same as the second flame retardant agent used in the adhesive layer. In some embodiments, the first flame retardant agent is not the same as the second flame retardant agent.

In one embodiment, the adhesive layer contains from 0.5 to 35 wt. % of the second flame retardant agent, based on the total weight of the adhesive layer, e.g., from 1 to 35 wt. %, from 2 to 35 wt. %, from 3 to 35 wt. %, from 0.5 to 30 wt. %, from 1 to 30 wt. %, from 2 to 30 wt. %, from 3 to 30 wt. %, from 0.5 to 25 wt. %, from 1 to 25 wt. %, from 2 to 25 wt. %, from 3 to 250 wt. %, from 0.5 to 20 wt. %, from 1 to 20 wt. %, from 2 to 20 wt. %, or from 3 to 20 wt. %. In terms of lower limits, in some embodiments of the flame retardant label, the adhesive layer may comprise greater than 0.5 wt. % of the second flame retardant agent, e.g., greater than 1 wt. %, greater than 2 wt. %, or greater than 3 wt. %, based on the total weight of the adhesive layer. In terms of upper limits, in some embodiments of the flame retardant label, the adhesive layer may comprise less than 35 wt. %. of the second flame retardant agent, e.g., less than 30 wt. %., less than 25 wt. %, or less than 20 wt. %.

In one embodiment, the adhesive layer has a coat weight ranging from 5 to 50 g/m², e.g., from 5 to 45 g/m², from 5 to 40 g/m², from 5 to 35 g/m², from 5 to 30 g/m², from 8 to 50 g/m², from 8 to 45 g/m², from 8 to 40 g/m², from 8 to 35 g/m², from 8 to 30 g/m², from 10 to 50 g/m², from 10 to 45 g/m², from 10 to 40 g/m², from 10 to 35 g/m², from 10 to 30 g/m², from 12 to 50 g/m², from 12 to 45 g/m², from 12 to 40 g/m², from 12 to 35 g/m², from 12 to 30 g/m², from 15 to 50 g/m², from 15 to 45 g/m², from 15 to 40 g/m², from 15 to 35 g/m², or from 15 to 30 g/m². In terms of lower limits, the adhesive layer may have a coat weight greater than 5 g/m², e.g., greater than 8 g/m², greater than 10 g/m², greater than 12 g/m², or greater than 15 g/m². In terms of upper limits, the adhesive layer may have a coat weight less than 50 g/m², e.g., less than 45 g/m², less than 40 g/m², less than 35 g/m², or less than 30 g/m².

### Release Liner

In some embodiments, the label may further comprise a liner. The liner layer may be releasable. In some embodiments, the liner layer may be positioned directly adjacent to the adhesive layer, on the opposite side of the adhesive layer from the film layer. In this regard, the liner layer may protect the adhesive layer before the flame retardant label is applied (or intended to be applied) to a substrate, e.g., an electrical device, such as during manufacture, printing, shipping, storage, and at other times. Any suitable material for a releasable liner may be used. Typical and commercially available releasable liners, which can be suitable for embodiments, can include a silicone-treated release paper or film, such as those available from Loparex, including products such as 1011, 22533 and 1 1404, CP Films, and Akrosil™.

In some embodiments, the liner layer comprises an embossed plastic paper. In some cases, the liner layer may comprise glassine coated with a liner polymer. For example, the liner layer may comprise glassine coated with polyethylene. In some embodiments, the liner polymer has a coat weight ranging from 5 to 50 g/m², e.g., from 5 to 45 g/m², from 5 to 40 g/m², from 5 to 35 g/m², from 5 to 30 g/m², from 8 to 50 g/m², from 8 to 45 g/m², from 8 to 40 g/m², from 8 to 35 g/m², from 8 to 30 g/m², from 10 to 50 g/m², from 10 to 45 g/m², from 10 to 40 g/m², from 10 to 35 g/m², from 10 to 30 g/m², from 12 to 50 g/m², from 12 to 45 g/m², from 12 to 40 g/m², from 12 to 35 g/m², from 12 to 30 g/m², from 15 to 50 g/m², from 15 to 45 g/m², from 15 to 40 g/m², from 15 to 35 g/m², or from 15 to 30 g/m². In terms of lower limits, the liner polymer may have a coat weight greater than 5 g/m², e.g., greater than 8 g/m², greater than 10 g/m², greater than 12 g/m², or greater than 15 g/m². In terms of upper limits, the liner polymer may have a coat weight less than 50 g/m², e.g., less than 45 g/m², less than 40 g/m², less than 35 g/m², or less than 30 g/m².

In one embodiment, the liner layer has a total coat weight ranging from 50 to 150 g/m², e.g., from 50 to 145 g/m², from 50 to 140 g/m², from 50 to 135 g/m², from 50 to 130 g/m², from 80 to 150 g/m², from 80 to 145 g/m², from 80 to 140 g/m², from 80 to 135 g/m², from 80 to 130 g/m², from 100 to 150 g/m², from 100 to 145 g/m², from 100 to 140 g/m², from 100 to 135 g/m², from 100 to 130 g/m², from 120 to 150 g/m², from 120 to 145 g/m², from 120 to 140 g/m², from 120 to 135 g/m², from 120 to 130 g/m². In terms of lower limits, the liner layer may have a total coat weight greater than 50 g/m², e.g., greater than 80 g/m², greater than 100 g/m², greater than 120 g/m². In terms of upper limits, the liner layer may have a total coat weight less than 150 g/m², e.g., less than 145 g/m², less than 140 g/m², less than 135 g/m², or less than 130 g/m².

The releasable liner may be positioned directly adjacent to the adhesive layer, on the opposite side of the adhesive layer from the film layer or primer layer. In this regard, the releasable liner may protect the adhesive layer before the label is applied (or intended to be applied) to an object or film layer, such as during manufacture, printing, shipping, storage, and at other times.

### Examples

The flame retardant label of Examples 1-3 were prepared and tested as follows. The flame retardant label of Examples 1 and 3 comprised, from top to bottom, a PET film layer, a primer layer, an adhesive layer, and a liner. The flame retardant label of Example 2 comprised, from top to bottom, a topcoat layer, a PET film layer, an adhesive layer, and a liner. In Examples 1-3, the PET film layer had a thickness of about 25 μm, the primer layer (Examples 1 and 3) and the topcoat layer (Example 2) had a thickness of about 10 μm, and the adhesive layer had a coat weight from 20 gsm to 30 gsm. The flame retardant labels of Examples 1-3 were each prepared with a clear PET liner.

In the prepared flame retardant labels of Examples 1-3, the primer layer and the topcoat layer were formed from a composition comprising a polyester resin, a flame retardant additive, an isocyanate crosslinker, wetting agents, dispersing agents, and solvents, e.g., MIBK and toluene. The composition of the primer layer for Example 1 and the topcoat layer for Example 2 is shown in Table 2. The wt. % of the coating composition is provided on a dry-basis, e.g., absent any solvent-based additives, for example, MIBK and toluene.

TABLE 2
Composition of Coating Layer

| | | Wt. % |
|---|---|---|
| | | (based on total weight |
| Component | Material | of coating composition) |
| Base polymer | Uralac ® SN862 (DSM) | 39.07% |
| Flame retardant | Exolit OP 945 (Clariant) | 39.07% |
| additive | | |
| Crosslinker | N75 (Covestro) | 17.80% |
| Wetting agent | BYK-170 (BYK) | 2.54% |
| Wetting agent | BYK 3550 (BYK) | 0.25% |
| Crosslinker | K-KAT 348 (King Industry) | 1.27% |
| catalyst | | |
| Solvent | MIBK | — |
| Solvent | Toluene | — |

The composition of the primer layer for Example 3 is shown in Table 3. The wt. % of the coating composition is provided on a dry-basis, e.g., absent any solvent-based additives, for example, MIBK and toluene.

TABLE 3
Composition of Coating Layer for Example 3

| | | Wt. % |
|---|---|---|
| | | (based on total weight |
| Component | Material | of coating composition) |
| Base polymer | Hypomer FS-2820 | 40.47% |
| | (Elementis) | |
| Flame retardant | Exolit OP 945 (Clariant) | 36.72% |
| additive | | |
| Crosslinker | N75 (Covestro) | 18.75% |
| Wetting agent | BYK-170 (BYK) | 2.54% |
| Wetting agent | BYK 3550 (BYK) | 0.25% |
| Crosslinker | K-KAT 348 (King Industry) | 1.27% |
| catalyst | | |
| Solvent | MIBK | — |
| Solvent | Toluene | — |

The adhesive layer was formed from a hydroxyl group substituted acrylic polymer resin, tackifier, flame retardant additive, epoxy resin, and, as solvents, MIBK and toluene. The formulation of the adhesive layer used in Examples 1-3 is shown in Table 4. The wt. % of the adhesive layer is provided on a dry-basis, e.g., absent any solvent-based additives, for example, MIBK and toluene.

TABLE 4
Formulation of Adhesive Layer

| | | Wt. % |
|---|---|---|
| | | (based on total weight |
| Component | Material | of adhesive layer) |
| Second base polymer | Etrac 7043 (Eternal) | 76.92% |
| Tackifier | GA-100 (Arakawa) | 18.46% |
| Flame retardant | Exolit OP 945 (Clariant) | 3.08% |
| additive | | |
| Wetting agent | NPSN-134X80 (Nanya) | 1.54% |
| Solvent | MIBK | — |
| Solvent | Toluene | — |

Examples 1 and 2 were subjected to the following tests: (i) 180 Degree Peel Adhesion on stainless steel for 20 minutes, (ii) Static Shear on stainless steel, and (iii) Loop Tack on stainless steel. The results of these tests are shown in Table 5.

The 180 Degree Peel Adhesion test was performed in accordance with testing standard ASTM D903 (2017).

Static Shear measures the time required to remove a test sample from a substrate, e.g., stainless steel, under a specific load. The test applies to the static force to remove an affixed adhesive from a standard flat surface when the load acts parallel to the surface in a pure shearing action. In Static Shear testing, the samples were cut into 12×51 mm test strips. The test strips were applied to brightly annealed, highly polished stainless steel test panels having a typical size of about 50×75 mm, making a sample overlay of 12×12 mm with the test panel. The sample portion on the test panel was rolled on using a 2 kg, 5.45 pli 65 shore “A” rubber-faced roller, rolling back and forth once, or one time at a rate of 30 cm/min. After a dwell time of at least 15 minutes under standard laboratory testing conditions, the test panels with the test strips were placed at a 2° angle from the vertical, and a load of 500 g/in² was attached to the end of the test strips. The time (in minutes) for the test sample to fail cohesively was measured by a timer.

Loop Tack measurements were made for strips that were about 25 mm (1 inch) wide using stainless steel as the substrate. Loop Tack measurements were taken using an Instron tester, which was lowered at a rate of about 300 mm/min and taken up at a draw rate of about 50 mm/min. Loop Tack values were taken to be the highest measured adhesion value observed during the test.

TABLE 5
Test Data of Properties of Example

| | | |
|---|---|---|
| Test | Example 1 | Example 2 |

| | | | | |
|---|---|---|---|---|
| Tack | 7 | N/Inch | 5 | N/Inch |
| 180° Peel Strength | 9 | N/Inch | 5 | N/Inch |
| Static Shear | >10,000 | min | >10,000 | min |

The flame-retardant label of Examples 1 and 2 exhibited good adhesion and tack properties. The unique combination of layers, each having a composition described herein, demonstrated good adhesion and repositioning performance. The results show that the adhesion of the label having a topcoat layer (Example 2) is lower than the label having a primer layer (Example 1). Without being bound by theory, it is postulated that the adhesion is lower for the for Example 1 is difference in stiffness between the coating layer and the topcoat layer.

Comparative Examples 1 and 2 were prepared in the same way as Example 1, but with different components, e.g., base polymers and/or flame-retardant additives. The labels of Comparative Examples 1 and 2 comprised, from top to bottom, a PET film layer, a primer layer, an adhesive layer, and a liner. The components of the primer layer in Comparative Examples 1 and 2 are shown in Table 6.

TABLE 6
Comparative Examples of Coating Layers

| | Comparative 1 | Comparative 2 |
|---|---|---|
| Polymer | Dynapol L206 | Dynapol LH828 |
| | (Evonik) | (Evonik) |
| Flame retardant | Exolit OP 935 | Exolit OP 935 |
| additive | (Clariant) | (Clariant) |
| Crosslinker | N75 (Covestro) | N75 (Covestro) |
| Wetting agent | BYK-170 (BYK) | BYK-170 (BYK) |
| Wetting agent | BYK 3550 | BYK 3550 |
| | (BYK) | (BYK) |
| Crosslinker | K-KAT 348 | K-KAT 348 |
| catalyst | (King Industry) | (King Industry) |
| Solvent | MIBK | MIBK |
| Solvent | Toluene | Toluene |

Additionally, Comparative Example 3 was prepared using the same coating composition as Example 1, however, the flame-retardant label included a non-flame-retardant adhesive.

Examples 1-3 and Comparatives 1-3 were subjected to tests to measure haze value and flame retardancy according to the aforementioned testing methods. Results of these tests are shown in Table 7.

TABLE 7
Test Data of Prepared Flame Retardant Labels

| Test | Ex. 1 | Ex. 2 | Ex. 3 | Comp. 1 | Comp. 2 | Comp. 3 |
|---|---|---|---|---|---|---|
| Haze | 12% | 16% | 13% | 60% | 45% | 12% |
| Value | | | | | | |
| UL-94 | VTM-0 | VTM-0 | VTM-0 | Cannot meet | VTM-2 | VTM-2 |
| Test | | | | VTM-2 | | |

Examples 1-3 unexpectedly and surprisingly demonstrated superior flame-retardant properties as well as good strength and transparency. The unique combination of components in the coating composition, e.g., a topcoat and/or a primer, provided for a layer that minimizes the negative effect of the presence of flame retardant additives on the optical properties of the label while exhibiting excellent flame-retardant properties. For example, Comparative Examples 1 and 2 had a haze value greater than 50%, while Examples 1-2 had a haze value of less than 20%. Although Comparative Example 3 achieved a haze value less than 20%, it did not exhibit good flame-retardant properties. That is, when the inventive coating composition was used in a label structure that did not include the flame-retardant adhesive layer described herein, the label did not exhibit good flame-retardant properties.

The following embodiments are contemplated. All combinations of features and embodiments are contemplated.

Embodiment 1: A coating composition comprising: a base polymer having a hydroxyl value greater than 100 mgKOH/g; a crosslinker comprising an isocyanate compound; and a flame retardant additive comprising a phosphinate compound.

Embodiment 2: An embodiment of embodiment 1, wherein the base polymer has a hydroxyl value ranging from 100 mgKOH/g to 350 mgKOH/g.

Embodiment 3: An embodiment of any one of the previous embodiments, wherein some of the hydroxy groups of the base polymer complex with some of the phosphinate compound to form a hydroxy-phosphinate complex.

Embodiment 4: An embodiment of any one of the previous embodiments, further comprising at least 20 wt. % hydroxy-phosphinate complex.

Embodiment 5: An embodiment of any one of the previous embodiments, wherein the coating composition has a haze value of less than 20%.

Embodiment 6: An embodiment of any one of the previous embodiments, wherein the weight ratio of polymer to flame retardant additive ranges from 0.2:1 to 10:1.

Embodiment 7: An embodiment of any one of the previous embodiments, wherein the polymer comprises a polyester, or a polyacrylate, or combinations thereof.

Embodiment 8: An embodiment of any one of the previous embodiments, wherein the base polymer is present in an amount ranging from 20 wt. % to 60 wt. %, based on the total weight of the composition.

Embodiment 9: An embodiment of any one of the previous embodiments, wherein the crosslinker is present in an amount ranging from 10 wt. % to 40 wt. %, based on the total weight of the composition.

Embodiment 10: An embodiment of any one of the previous embodiments, wherein the flame retardant additive is present in an amount ranging from 20 wt. % to 60 wt. %, based on the total weight of the composition.

Embodiment 11: An embodiment of any one of the previous embodiments, wherein the crosslinker consists of the isocyanate compound.

Embodiment 12: An embodiment of any one of the previous embodiments, wherein the phosphinate compound comprises methylethyl phosphinates, diethyl phosphinates, aluminum methylethyl phosphinate, aluminum diethyl phosphinate, zinc methylethyl phosphinate, zinc diethyl phosphinate, aluminum phosphinate, magnesium phosphinate, calcium phosphinate, zinc phosphinate, or combinations thereof.

Embodiment 13: An embodiment of any one of the previous embodiments, wherein the phosphinate compound comprises aluminum diethyl phosphinate.

Embodiment 14: An embodiment of any one of the previous embodiments, wherein the flame retardant additive has an average particle size distribution less than 2 microns.

Embodiment 15: An embodiment of any one of the previous embodiments, wherein the coating composition has a UL rating of VTM-0.

Embodiment 16: An embodiment of any one of the previous embodiments, wherein the polymer comprises a hydroxyl value greater than 100 mgKOH/g, wherein the flame retardant additive comprises aluminum diethyl phosphinate ranging from 20 wt. % to 60 wt. %, based on the total weight of the composition, and wherein the coating composition has a UL rating of VTM-0.

Embodiment 17: An embodiment of any one of the previous embodiments, wherein the polymer comprises a hydroxyl value greater than 100 mgKOH/g, wherein the phosphinate compound comprises aluminum diethyl phosphinate having an average particle size distribution less than 2 microns, and wherein the coating composition has a haze value less than 20%.

Embodiment 18: An embodiment of any one of the previous embodiments, wherein the polymer comprises a polyester or a polyacrylate having a hydroxyl value greater than 100 mgKOH/g, wherein the flame retardant additive comprises aluminum diethyl phosphinate ranging from 20 wt. % to 60 wt. %, based on the total weight of the composition, wherein the coating composition has a UL rating of VTM-0, and wherein the coating composition has a haze value of less 20%.

Embodiment 19: A flame retardant label comprising: a coating layer comprising a base polymer having a hydroxyl value greater than 100 mgKOH/g, a crosslinker comprising an isocyanate compound; and a flame retardant additive comprising a phosphinate compound; a film layer; and an adhesive layer, comprising a second base polymer, a second flame retardant agent, a tackifier, and a second crosslinker.

Embodiment 20: An embodiment of embodiment 19, wherein the coating layer is a topcoat layer.

Embodiment 21: An embodiment of any one of embodiments 19 or 20, wherein the coating layer is a primer layer.

Embodiment 22: An embodiment of any one of embodiments 19-21, wherein the second base polymer comprises a polyester, polyacrylate, or combinations thereof, wherein the second base polymer has a hydroxyl value less than 100 mgKOH/g, wherein the second crosslinker comprises isocyanate, epoxy, or combinations thereof.

Embodiment 23: An embodiment of any one of embodiments 19-22, wherein the weight ratio of the tackifier in the adhesive layer to the second base polymer is from 1:10 to 1.5:1.

Embodiment 24: A method for forming a flame-resistant label, the method comprising: providing a substrate; applying a coating composition to the substrate, the coating composition comprising: a polymer having a hydroxyl value greater than 100 mgKOH/g; a crosslinker comprising an isocyanate compound; a flame retardant additive comprising a phosphinate compound; and curing the coating composition.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

1. A coating composition comprising:
a base polymer having a hydroxyl value greater than 100 mgKOH/g;
a crosslinker comprising an isocyanate compound; and
a flame retardant additive comprising a phosphinate compound;
wherein the coating composition has a haze value of less than 20%;
wherein the coating composition has a UL rating of VTM-0.

2. The coating composition of claim 1, wherein the base polymer has a hydroxyl value ranging from 100 mgKOH/g to 350 mgKOH/g.

3. The coating composition of claim 1, wherein some of the hydroxy groups of the base polymer complex with some of the phosphinate compound to form a hydroxy-phosphinate complex.

4. The coating composition of claim 1, further comprising at least 20 wt. % hydroxy-phosphinate complex.

5. (canceled)

6. The coating composition of claim 1, wherein the weight ratio of polymer to flame retardant additive ranges from 0.2:1 to 10:1.

7. The coating composition of claim 1, wherein the polymer comprises a polyester, or a polyacrylate, or combinations thereof.

8. The coating composition of claim 1, wherein the base polymer is present in an amount ranging from 20 wt. % to 60 wt. %, based on the total weight of the composition.

9. The coating composition of claim 1, wherein the crosslinker is present in an amount ranging from 10 wt. % to 40 wt. %, based on the total weight of the composition.

10. The coating composition of claim 1, wherein the flame retardant additive is present in an amount ranging from 20 wt. % to 60 wt. %, based on the total weight of the composition.

11. The coating composition of claim 1, wherein the crosslinker consists of the isocyanate compound.

12. The coating composition of claim 1, wherein the phosphinate compound comprises methylethyl phosphinates, diethyl phosphinates, aluminum methylethyl phosphinate, aluminum diethyl phosphinate, zinc methylethyl phosphinate, zinc diethyl phosphinate, aluminum phosphinate, magnesium phosphinate, calcium phosphinate, zinc phosphinate, or combinations thereof.

13. The coating composition of claim 1, wherein the phosphinate compound comprises aluminum diethyl phosphinate.

14. The coating composition of claim 1, wherein the flame retardant additive has an average particle size distribution less than 2 microns.

15. (canceled)

16. The coating composition of claim 1, wherein the polymer comprises a hydroxyl value greater than 100 mgKOH/g, wherein the flame retardant additive comprises aluminum diethyl phosphinate ranging from 20 wt. % to 60 wt. %, based on the total weight of the composition, and wherein the coating composition has a UL rating of VTM-0.

17. The coating composition of claim 1, wherein the polymer comprises a hydroxyl value greater than 100 mgKOH/g, wherein the phosphinate compound comprises aluminum diethyl phosphinate having an average particle size distribution less than 2 microns, and wherein the coating composition has a haze value less than 20%.

18. The coating composition of claim 1, wherein the polymer comprises a polyester or a polyacrylate having a hydroxyl value greater than 100 mgKOH/g, wherein the flame retardant additive comprises aluminum diethyl phosphinate ranging from 20 wt. % to 60 wt. %, based on the total weight of the composition, wherein the coating composition has a UL rating of VTM-0, and wherein the coating composition has a haze value of less 20%.

19. A flame retardant label comprising:
a coating layer comprising a base polymer having a hydroxyl value greater than 100 mgKOH/g, a crosslinker comprising an isocyanate compound; and a flame retardant additive comprising a phosphinate compound;
a film layer; and
an adhesive layer, comprising a second base polymer, a second flame retardant agent, a tackifier, and a second crosslinker;
wherein the coating layer has a haze value of less than 20%; and
wherein the coating layer has a UL rating of VTM-0.

20. The flame retardant label of claim 19, wherein the coating layer is a topcoat layer.

21. The flame retardant label of claim 20, wherein the coating layer is a primer layer.

22. The flame retardant label of claim 19, wherein the second base polymer comprises a polyester, polyacrylate, or combinations thereof, wherein the second base polymer has a hydroxyl value less than 100 mgKOH/g, wherein the second crosslinker comprises isocyanate, epoxy, or combinations thereof.

23. The flame retardant label of claim 19, wherein the weight ratio of the tackifier in the adhesive layer to the second base polymer is from 1:10 to 1.5:1.

24. A method for forming a flame-resistant label, the method comprising:
providing a substrate;
applying a coating composition to the substrate, the coating composition comprising:
a polymer having a hydroxyl value greater than 100 mgKOH/g;
a crosslinker comprising an isocyanate compound;
a flame retardant additive comprising a phosphinate compound; and curing the coating composition;
wherein the coating composition has a haze value of less than 20%;
wherein the coating composition has a UL rating of VTM-0.
